(19) United States
(12) Patent Application Publication
(10) Pub. No.: US 2003/0092412 A1
(43) Pub. Date: May 15, 2003

(54) Automatic gain control circuit with multiple input signals

(75) Inventor: Miaochen Wu, Acton, MA (US)

Correspondence Address: Leo R. Reynolds, Esq., HAMILTON, BROOK, SMITH & REYNOLDS, P.C., 530 Virginia Road, P.O. Box 9133, Concord, MA, 01742-9133, US

(73) Assignee: Narad Networks, Inc, Westford, MA (US)

(21) Appl. No.: 10/010,951

(22) Filed: Nov. 13, 2001

(51) Int. Cl. H04B 7/00

(52) U.S. Cl. 455/234.1; 455/234.2

(57) ABSTRACT

An automatic gain control circuit in a receiver estimates an AGC gain using information from an estimated amplitude signal derived from a received signal before a carrier signal is recovered from the received signal. The carrier signal is recovered from the received signal using the estimated AGC gain. After the carrier signal is recovered, the amplitude of the estimated amplitude signal decreases below the amplitude of the recovered carrier signal. The Automatic Gain Control circuit uses the amplitude of the recovered I and/or Q signal to accurately set the AGC gain.

### RELATED APPLICATIONS

This application is related to Attorney Docket No. 3070.1008-000 entitled “Frequency Acquisition and Locking Detection Circuit for Phase Lock Loop” by Miaochen Wu, et al., Attorney Docket No.: 3070.1010-000 entitled “Differential Slicer Circuit for Data Communication”, by Miaochen Wu, and Attorney Docket No.: 3070.1011-000 entitled “Slicer Circuit With Ping Pong Scheme For Data Communication”, by Dev Gupta, et al., filed on even date herewith. The entire teachings of the above applications are incorporated herein by reference.

### BACKGROUND OF THE INVENTION

A broadband modem typically transmits data at data rates greater than 10 Mbps over a coaxial cable. A cable modem can use Quadrature Amplitude Modulation (QAM) to obtain a high data rate. Quadrature Amplitude Modulation (QAM) is a method for doubling effective bandwidth by combining two Amplitude Modulated carriers in a single channel. Each of the two carriers in the channel has the same frequency but differs in phase by 90 degrees. One carrier is called the In-phase (I) signal and the other carrier is called the Quadrature (Q) signal.

A receiver receiving the QAM signal typically includes an amplifier with Automatic Gain Control (AGC) circuitry. The AGC circuitry senses the peak to peak voltage at the output of the amplifier and adjusts the gain of the amplifier so that the peak to peak voltage is constant regardless of the peak to peak voltage of the received QAM signal.

In operation, the amplifier's output signal is peak-detected to provide a D.C. voltage. The D.C. voltage is amplified and used to control the gain of the amplifier. The D.C. voltage is proportional to the received QAM signal. Thus, the greater the peak to peak voltage of the received QAM signal, the greater the D.C. voltage. Increasing the D.C. voltage reduces the gain of the amplifier.

An Automatic Gain Control Circuit typically compares the D.C. voltage corresponding to the peak to peak voltage of the I carrier in the received QAM signal with a reference D.C. voltage level in a differential amplifier. The D.C. voltage level on the output of the differential amplifier is an indication of whether the gain should be increased or decreased.

### SUMMARY OF THE INVENTION

It is difficult to set the proper AGC gain before the carriers are recovered by the receiver. However, without the proper AGC gain, it is hard to recover the carriers.

According to the present approach, information from an estimated amplitude signal or a recovered carrier is used to set the gain of the AGC. A first peak detector detects a signal peak voltage from an estimated amplitude signal or from a carrier signal recovered from a received signal. An integrator sets the gain dependent on a difference between the peak signal voltage and a peak reference voltage.

A converter converts the estimated amplitude signal, the recovered carrier signal and a reference signal to a same common mode. The first peak detector detects the signal peak voltage from the estimated amplitude signal and the converted recovered carrier signal. A second peak detector detects the peak reference voltage from the converted reference signal.

The peak signal voltage is detected from the estimated amplitude signal until the amplitude of the carrier signal decreases below the amplitude of the estimated amplitude signal. The peak signal is detected from the I signal after the carrier is recovered.

In one embodiment the carrier signal is an I signal. In alternate embodiments, the carrier signal can be a Q signal or include an I signal and a Q signal.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates an embodiment of a network configuration of intelligent network elements for providing point to point data links between intelligent network elements in a broadband, bidirectional access system.

FIG. 2 is a block diagram of an embodiment of any one of the network elements shown in FIG. 1.

FIG. 3 is a diagram of a frame structure for use in the network of FIG. 1;

FIG. 4 is a block diagram of a receiver in any of the modems in the network element shown in FIG. 2.

FIG. 5A is a block diagram of an Automatic Gain Control (AGC) circuit in the receiver shown in FIG. 4 according to the principles of the present invention;

FIG. 5B is a circuit diagram of the threshold voltage circuit supplying the reference voltages to the AGC circuit shown in FIG. 5A.

FIG. 6A is a graph illustrating the non-linear relationship between the estimated amplitude signal and the recovered I (or Q) signal;

FIG. 6B is a signal diagram illustrating the relationship between the estimated amplitude signal and the recovered I signal;

FIG. 7A is a block diagram of an embodiment of an estimated amplitude signal generation circuit in the SYNC timing circuit 472 shown in FIG. 3;

FIG. 7B is a circuit diagram of the differential amplifiers and biasing circuit shown in FIG. 5A; and

FIG. 8 is a circuit diagram of the peak detectors shown in FIG. 5A.

### DETAILED DESCRIPTION OF THE INVENTION

A description of preferred embodiments of the invention follows.

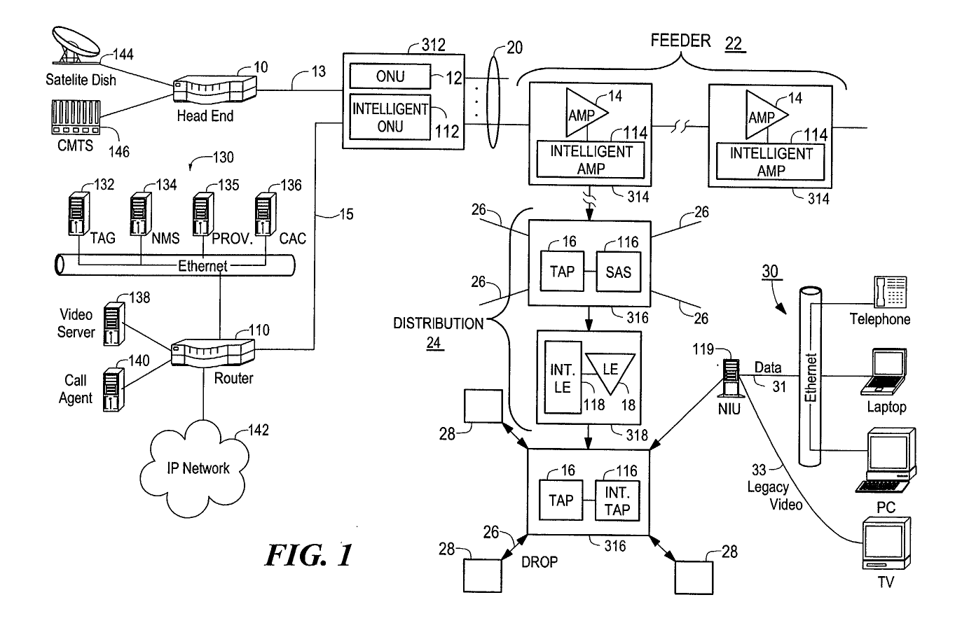

FIG. 1 illustrates an embodiment of a network configuration of intelligent network elements for providing point to point data links between intelligent network elements in a broadband, bidirectional access system. This network configuration is described in U.S. patent application Ser. No. 09/952,321 filed Sep. 13, 2001 entitled “Broadband System With Topology Discovery”, by Gautam Desai, et al, the entire teachings of which are incorporated herein by reference. The network configuration, also referred to herein as an Access Network, includes intelligent network elements each of which uses a physical layer technology that allows data connections to be carried over coax cable distribution facilities from every subscriber. In particular, point-to-point data links are established between the intelligent network elements over the coax cable plant. Signals are terminated at the intelligent network elements, switched and regenerated for transmission across upstream or downstream data links as needed to connect a home to the headend.

The intelligent network elements are interconnected using the existing cable television network such that the point-to-point data links are carried on the cable plant using bandwidth that resides above the standard upstream/downstream spectrum. For example, the bandwidth can reside at 1025 to 1125 MHZ (upstream) and 1300 to 1400 MHZ (downstream) or 100 Mbps upstream and downstream bandwidths can be provided in the spectrum 750 to 860 MHZ or duplexing channel spectrums can be allocated in the 777.5 MHz to 922.5 MHz regime for 100 Mb/s operation and in the 1 GHz to 2 GHz regime for 1 Gb/s operation.

The intelligent network elements include an intelligent optical network unit or node 112, intelligent trunk amplifier 114, intelligent tap or subscriber access switch (SAS) 116, intelligent line extender 118 and network interface unit (NIU) 119. A standard residential gateway or local area network 30 connected to the NIU 119 at the home is also shown. Note that the trunk amplifier 114 is also referred to herein as a distribution switch (DS). The configuration shown includes ONU assembly 312 comprising standard ONU 12 and intelligent ONU 112 also referred to herein as an optical distribution switch (ODS). Likewise, trunk amplifier or DA assembly 314 includes conventional trunk amp 14 and intelligent trunk amp 114; cable tap assembly 316 includes standard tap 16 and subscriber access switch 116; and line extender assembly 318 includes standard line extender 18 and intelligent line extender 118.

The intelligent ONU or ODS is connected over line 15 to a router 110, which has connections to a server farm 130, a video server 138, a call agent 140 and IP network 142. The server farm 130 includes a Tag/Topology server 132, a network management system (NMS) server 134, a provisioning server 135 and a connection admission control (CAC) server 136, all coupled to an Ethernet bus which are described in U.S. patent application Ser. No. 09/952,321 filed Sep. 13, 2001 entitled “Broadband System With Topology Discovery”, by Gautam Desai, et al, the entire teachings of which are incorporated herein by reference.

A headend 10 is shown having connections to a satellite dish 144 and CMTS 146. To serve the legacy portion of the network, the headend 10 delivers a conventional amplitude modulated optical signal to the ONU 12. This signal includes the analog video and DOCSIS channels. The ONU performs an optical to electrical (O/E) conversion and sends radio frequency (RF) signals over feeder coax cables 20 to the trunk amplifiers or DAs 14. Each DA along the path amplifies these RF signals and distributes them over the distribution portion 24.

The present system includes intelligent network elements that can provide high bandwidth capacity to each home. In the Access Network of the present invention, each intelligent network element provides switching of data packets for data flow downstream and statistical multiplexing and priority queuing for data flow upstream. The legacy video and DOCSIS data signals can flow through transparently because the intelligent network elements use a part of the frequency spectrum of the coax cable that does not overlap with the spectrum being used for legacy services.

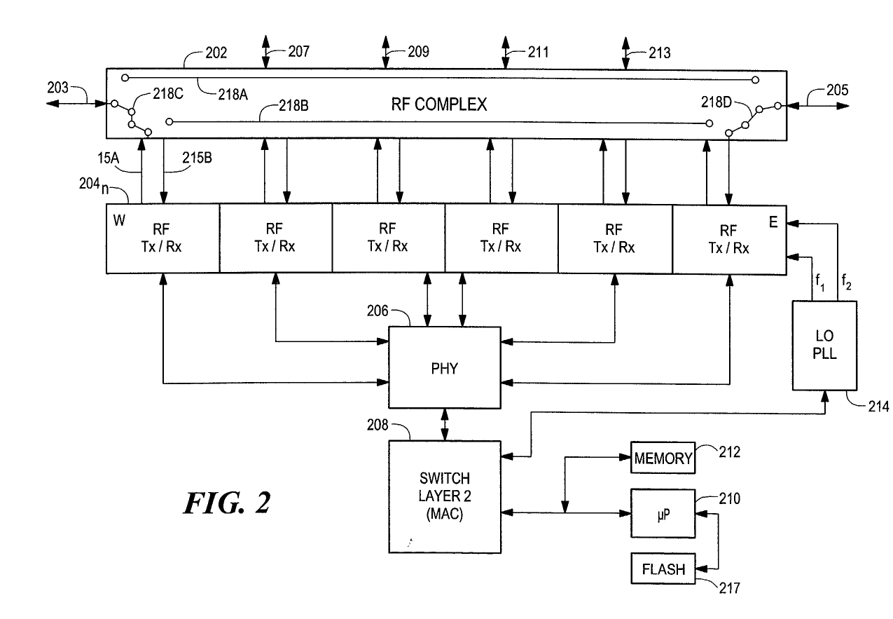

FIG. 2 is a block diagram of an embodiment of any one of the network elements shown in FIG. 1. The network element includes an RF complex 202, RF transmitter/receiver pairs or modems 204a-204n, a PHY (physical layer) device 206, a switch 208, microprocessor 210, memory 212, flash memory 217 and a local oscillator/phase locked loop (LO/PLL) 214. All of the components are common to embodiments of the ODS, DS, SAS and NIU shown in FIG. 1. The ODS further includes an optical/electrical interface. The NIU further includes a 100BaseT physical interface for connecting to the Home LAN 30 (FIG. 2). In addition, the RF complex is shown as having a bypass path 218A and a built in self test path 218B controlled by switches 218C, 218D which are described further herein.

The number of modems, 204n generally, depends on the number of links that connect to the network element. For example, DS 314 (FIG. 1) has five ports and thus has five modems 204. A SAS 316 (FIG. 1) has six ports and thus has six modems 204. The network element in FIG. 2 is shown having six ports indicated as ports 203, 205, 207, 209, 211 and 213.

The PHY device 206 provides physical layer functions between each of the modems 204 and the switch 208. The switch 208, controlled by the microprocessor 210, provides layer 2 switching functions and is referred to herein as the Media Access Control (“MAC”) device or simply MAC. The LO/PLL 214 provides master clock signals to the modems 204 at the channel frequencies.

A modulation system with spectral efficiency of 4 bits/s/Hz is used in the RF modem 604n (FIG. 2) to provide high data rates within the allocated bandwidth. In particular, 16-state Quadrature Amplitude Modulation (16-QAM) is preferably used, which involves the quadrature multiplexing of two 4-level symbol channels. Embodiments of the network elements of the present system described herein support 100 Mb/s and 1 Gb/s Ethernet transfer rates, using the 16-QAM modulation at symbol rates of 31 or 311 MHZ.

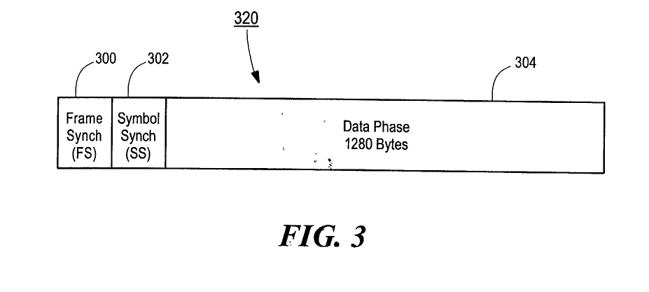

FIG. 3 is a block diagram of a frame structure 320 for use in the network of FIG. 1. The frame structure 320 is used to transmit a frame over the network. The frame structure 320 includes frame synchronization 300, symbol synchronization 302 and a data phase 304. In a particular embodiment, frame and symbol synchronization is performed every 10 micro seconds (μs) followed by 1280 bytes of Data Phase 621, with frame synchronization (FS) 300 for 1 μs and the symbol synchronization (SS) 302 for 400 nano seconds (ns). It should be understood that other frame structures are possible and the frame structure described is only an example.

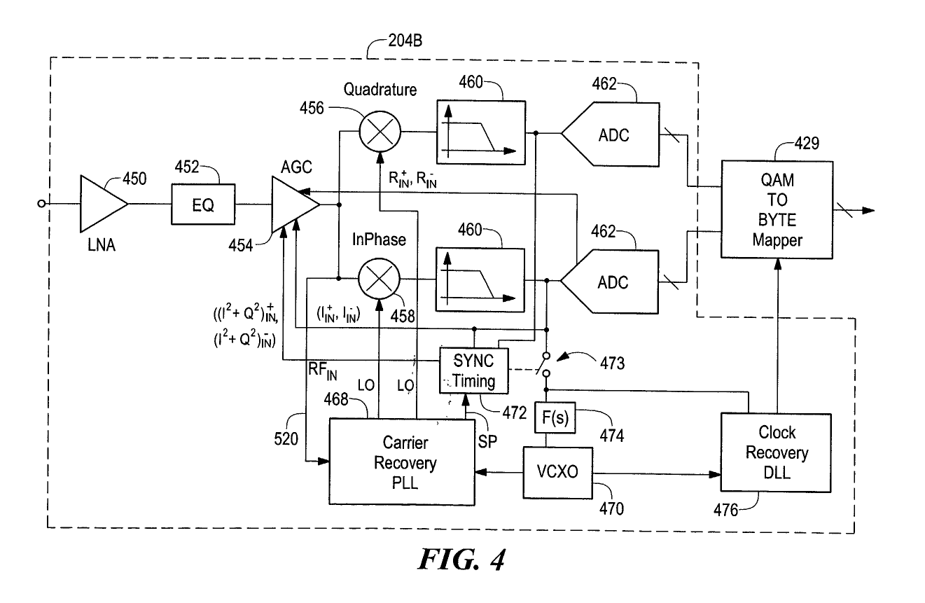

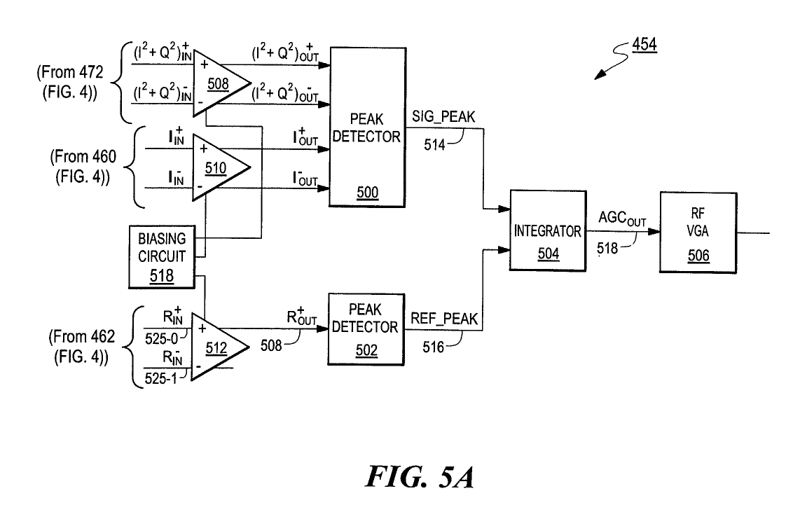

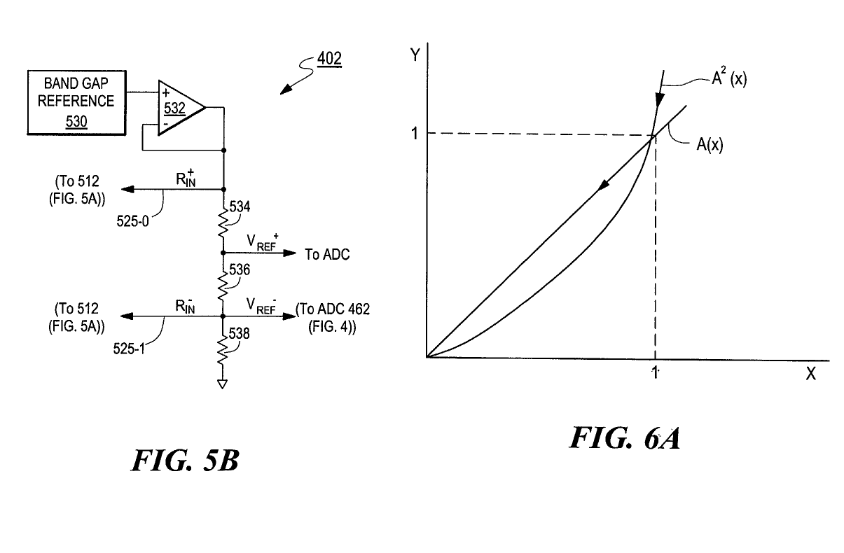

FIG. 4 is a block diagram of a receiver 204B in any of the modems 204 in the network element shown in FIG. 2. The receiver 204B receives a quadrature-multiplexed signal which includes in-phase (I) and quadrature (Q) carriers. At the front end, the receiver section 204B includes low-noise amplifier (LNA) 450, equalizer 452 and automatic gain control (AGC) 454. The received signal from PHY 206 (FIG. 2) is boosted in the LNA 450 and corrected for frequency-dependent line loss in the equalizer 452. The equalized signal is passed through the AGC stage 454 to I and Q multiplier stages 456, 458, low pass filters 460 and analog-to-digital converters (ADC) 462. After down-conversion in the multiplier stages 456, 458 and low-pass filtering, the I and Q channels are digitized and passed on to the QAM-to-byte mapper 429 for conversion to a byte-wide data stream in the PHY device 406 (FIG. 2).

Carrier and clock recovery, for use in synchronization at symbol and frame levels, are performed during periodic training periods. A carrier recovery PLL circuit 468 provides the I and Q carriers from the RF carrier (RFin) 520 to the multipliers 456, 458. The RF carrier 520 includes the I and Q carriers. A clock recovery delay locked loop (DLL) circuit 476 provides a clock to the QAM-to-byte mapper 449. During each training period, PLL and DLL paths that include F(s) block 474 and voltage controlled oscillator (VCXO) 470 are switched in using normally open switch 473 under control of SYNC timing circuit 472 in order to provide updated samples of phase/delay error correction information.

The AGC stage 454 amplifies the equalized signal to output an amplified signal with a constant peak to peak voltage. In one embodiment the gain of the AGC stage 454 is selected to output an amplified signal with a peak to peak voltage of 300 milli Volts (mV).

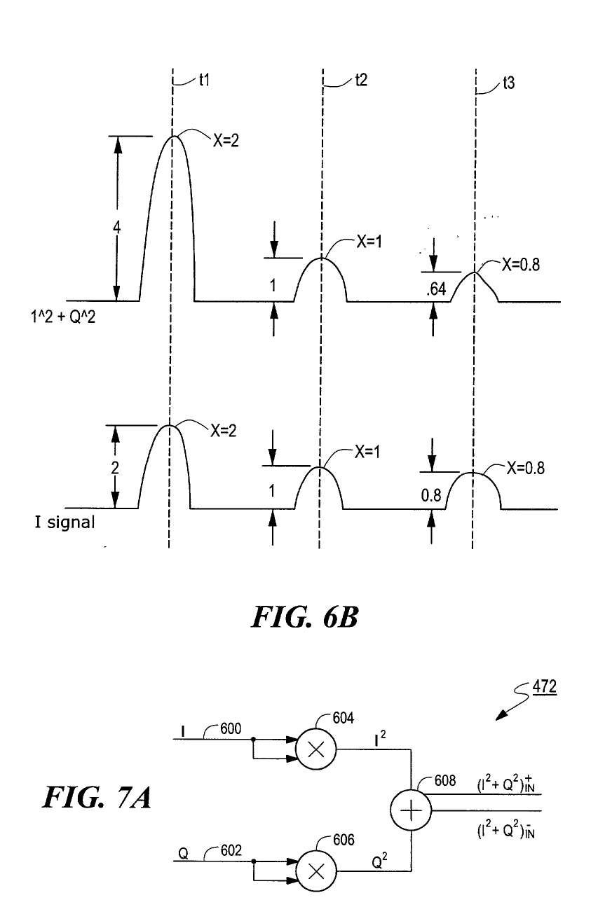

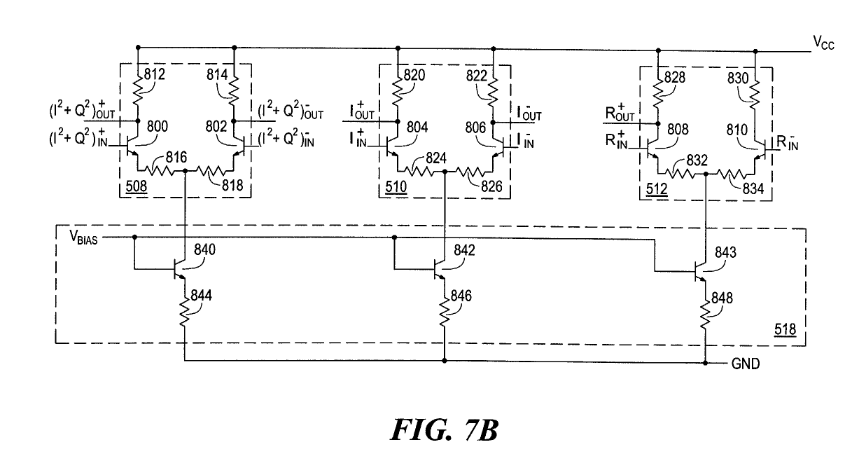

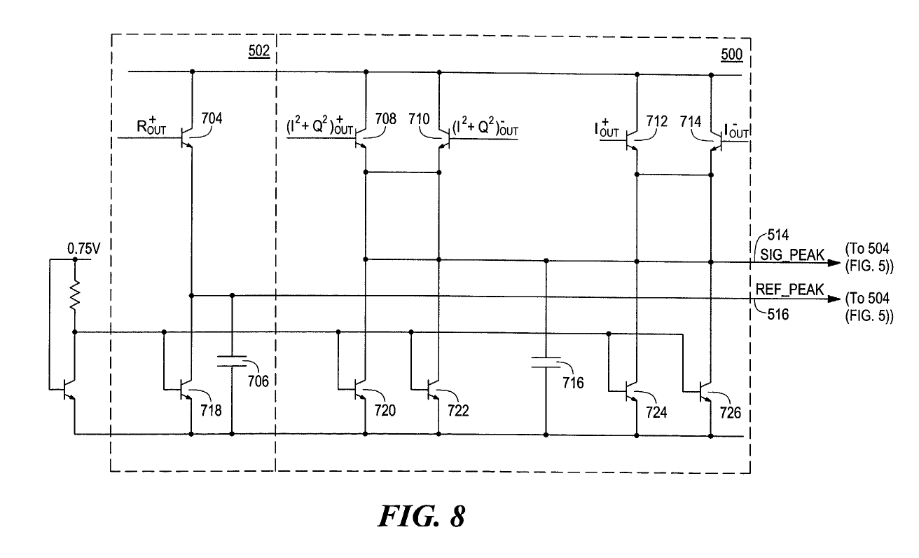

FIG. 5A is a block diagram of the Automatic Gain Control (AGC) stage 454 in the receiver 204B shown in FIG. 4 according to the principles of the present invention. The AGC stage 454 includes differential amplifiers 508, 510, 512, peak detectors 500, 502, an integrator 504 and an RF Variable Gain Amplifier (VGA) 506. An estimated amplitude signal (Iˆ 2+Qˆ 2) from the SYNC timing circuit 472 (FIG. 3) and the I signal from low pass filters 460 (FIG. 3) are input to the AGC stage 454.

Each of the differential amplifiers 508, 510, 512 is open loop; that is, there is nothing coupled between the inputs and the outputs. In theory, an ideal open loop differential amplifier rejects any common mode voltage when there is no differential input voltage; that is, the voltage level on both inputs is the same. The ideal open loop differential amplifier outputs a differential voltage of 0 V when there is no differential input voltage. In practice, even with no differential input voltage, there is a small differential output voltage which is dependent on the open loop common-mode gain of the differential amplifier. To minimize the effect of different open-loop common mode gain in each of the differential amplifiers, the same biasing voltage and same degeneration resistor are applied to each differential amplifier 508, 510, 512 by the biasing circuit 518. Also, the components in each of the differential amplifiers are selected so that the differential amplifiers are matched to minimize the difference in the common mode voltage.

By applying the same biasing voltage and with same degeneration resistor to each differential amplifier 508, 510, 512, a differential estimated amplitude signal, I signal and reference signal are converted to a converted differential estimated amplitude signal, converted I signal and converted reference signal having the same common mode voltage. The converted signals output from the differential amplifiers 508, 510, 512 are coupled to peak detectors 500, 502.

Converted differential Iˆ 2+Qˆ 2 signal and converted I signal are coupled to peak detector 500. A converted reference signal 508 dependent on a differential reference voltage Rin+, Rin− output by the ADC 462 (FIG. 4) is coupled to peak detector 502. The reference voltage Rᵢₙ^{+,}Rᵢₙ⁻ is output by the same reference voltage circuit outputting the reference voltages for a slicer circuit in the ADC 462 (FIG. 4) so that the incoming I and Q signal magnitude controlled by the AGC tracks the slicer reference. The slicer circuit is described in co-pending U.S. Patent Application Attorney Docket No. 3070-1010-00 entitled “Differential Slicer Circuit for Data Communication” by Miaochen Wu, the entire teachings of which are incorporated herein by reference. Each peak detector detects the peak voltage on the input signal and outputs the detected peak voltage on an output signal. The peak detector typically includes a capacitor. While the input voltage is greater than the previously detected peak voltage, the capacitor charges up to the input voltage. While the input voltage is less than the previously detected peak voltage, the peak detector maintains the output voltage at the previously detected peak voltage level.

Peak detector 500 outputs the signal peak voltage detected on either the converted estimated amplitude signal or the converted I signal on the peak signal 514. Peak detector 502 outputs the reference peak voltage 516. The difference between the signal peak 514 and the reference peak 502 represents the amplitude difference between the incoming signals (Iˆ 2+Qˆ 2, and I) and the reference signal. The difference is integrated through an integrator 504. The output of the integrator controls the Variable Gain Amplifier (VGA) 506 to set the AGC gain for amplifying the equalized signal.

The converted differential signal for the estimated amplitude signal generates the peak signal 514 in peak detector 500. The peak signal 514 is dependent on whether the peak voltage is detected on the estimated amplitude signal or the I signal. Initially, the amplitude of the estimated amplitude signal is larger and the peak voltage detected is used to estimate the AGC gain. After the I signal is recovered, the peak voltage is detected from the I signal because the amplitude of the I signal is greater than the amplitude of the estimated amplitude signal. As the amplitude of the converted differential signal for the estimated amplitude signal decreases below the amplitude of the I signal, the peak signal 514 detected from the I signal fine tunes and maintains the AGC gain after the I signal is recovered.

FIG. 5B is a circuit diagram of the threshold voltage circuit supplying the reference voltages to the AGC circuit shown in FIG. 5A. The reference voltage Rᵢₙ⁺, Rᵢₙ⁻ coupled to differential amplifier 512 (FIG. 5A) is output by the same threshold voltage circuit supplying the reference voltages to the AGC circuit so that the incoming I and Q signals match and track the slicer reference.

The threshold voltage circuit includes a bandgap reference 530, a buffer 532 and resistors 534, 536, 538. The voltage level of threshold voltages Vref⁺, Vref⁻ and Rᵢₙ⁺, Rᵢₙ⁻ are dependent on the voltage level on the output of buffer 514 and the resistance values of resistors 534, 536, 538. V_{REF}⁺, V_{REF}⁻ are coupled to the ADC 462. Rᵢₙ⁻ is the same reference voltage as the V_{REF}⁻. Thus Rᵢₙ⁺, Rᵢₙ⁻ tracks the slicer reference V_{REF}⁺, V_{REF}⁻.

FIG. 6A is a graph illustrating the non-linear relationship between the estimated amplitude signal and the recovered I (or Q) signal. There is a non-linear relationship between the amplitude of the Iˆ 2+Iˆ 2 and the I signal as the amplitude of the signals decreases when the carriers are recovered. The graph shows A²(x) and A(x). A(x) corresponds to the function y=x. A(x) is a linear function, for example, for x=0.1, 0.2, 0.3, . . . , 1, 2, 3, A(x)=0.1, 0.2, 0.3, . . . , 1, 2, 3 because y=x. A²(x) is a non-linear function, for example, for x=0.1, 0.2, 0.3, . . . , 1, 2, 3, A²(x)=0.01, 0.04, 0.09, . . . 1, 4.9 because y=x². Thus for values of x greater than 1, A(x) is less than A²(x) and for values of x less than 1 A(x) is greater than A²(x).

FIG. 6B is a signal diagram illustrating the relationship between the estimated amplitude signal and the recovered I (or Q) signal. At time t1 before the carrier is recovered, x is 2 and the amplitude of the estimated amplitude signal (Iˆ 2+Qˆ 2) is 4 (x²) which is greater than 2 (x), the amplitude of the I signal. Thus, the peak voltage is detected from the Iˆ 2+Qˆ 2 signal. At time t2, the carrier is recovered, x=1 and the amplitude of the Iˆ 2+Qˆ 2 signal and the I signal is equal. Thus, the peak voltage can be detected from either the Iˆ 2+Qˆ 2 signal or the I signal. At time t3, the amplitude of the I signal is greater than that of the Iˆ 2+Qˆ 2 signal with x=0.8 and x²=0.64. Thus, the peak voltage is detected from the I signal.

FIG. 7A is a block diagram of an embodiment of an estimated amplitude signal generation circuit in the SYNC timing circuit 472 shown in FIG. 4. The amplitude of the estimated amplitude signal provides an estimate for the AGC gain until the I and Q signals are recovered. The estimated amplitude signal is used to estimate the AGC gain because the estimated amplitude signal is independent of the I and Q signal recovery a D.C. signal.

In theory, the estimated amplitude signal is a signal related only to I and Q signals which can be a D.C. signal. The estimated amplitude signal is derived as follows: The I signal can be represented as A cos wt. The Q signal is 90° out of phase with the I signal and can be represented as A sin wt. Summing the square of the I signal and the square of the Q signal results in a signal that can be represented as A² cos² wt+A² sin² wt. Replacing for cos² wt+sin² wt=1, results in a signal with a voltage of amplitude A². A is a function of time.

In one embodiment, the AGC gain is selected to output an amplified signal with a peak to peak voltage of 300 milli Volts (mV). The I signal 600 is squared in multiplier 604. The Q signal 602 is squared in multiplier 606. A squared I signal Iˆ 2 is output by multiplier 604 and a squared Q signal Qˆ 2 is output by multiplier 606. The Iˆ 2 and Qˆ 2 signals are summed in adder 608. Adder 608 outputs the estimated amplitude signal, that is, a signal of amplitude A².

Fine tuning of the ACG gain is performed after the I and Q signals are recovered by the I signal, Q signal or both. The estimated amplitude signal cannot be used to fine tune the AGC gain because the amplitude of the estimated amplitude signal changes dependent on temperature and power supply voltages, and it has nonlinear relationship with the I and Q signals. After the I signal and Q signal are recovered, the amplitude of the estimated amplitude signal decreases faster than the I signal and Q signal, thereby allowing the I signal to generate the peak signal 514 in peak detector 500.

FIG. 7B is a circuit diagram of the differential amplifiers 508, 510, 512 and the biasing circuit 518 shown in FIG. 5A. The biasing circuit 518 injects a biasing voltage to each differential amplifier 508, 510, 512. The biasing voltage is injected to differential amplifier 508 through transistor 840, to differential amplifier 510 through transistor 842 and to differential amplifier 512 through transistor 843. The circuit for injecting the common mode voltage is the same for all the differential amplifiers 508, 510, 512 and will be described for differential amplifier 508.

Differential amplifier 508 includes transistors 800, 802 and resistors 812, 814, 816, 818. The common mode output voltage is dependent on the voltage level injected from the biasing circuit 518 between resistors 816, 818 and resistors 812, 814 which are common to all the differential amplifiers 508, 510, 512. When there is a common mode input on (Iˆ 2+Qˆ 2)⁺_{OUT}, (Iˆ 2+Qˆ 2)⁻_{OUT;} that is, the same signal is applied to (Iˆ 2+Qˆ 2)⁺_{OUT} and (Iˆ 2+Qˆ 2)⁻_{OUT} and there is no differential input voltage, if each side of the differential amplifier is identical, the differential output voltage will be about zero volts.

FIG. 8 is a block diagram of peak detectors 500 and 502 shown in FIG. 5A. Peak detector 502 generates the peak reference signal 516 and includes transistor 704 and capacitor 706. The emitter of transistor 704 is coupled to capacitor 706 and to peak reference signal 516. Transistor 704 is turned ‘on’ and an emitter current flows when the voltage level on the reference signal R_{OUT}⁺ coupled to the base of transistor 704 is greater than the voltage level on the peak reference signal 516 coupled to the emitter of transistor 704. While transistor 704 is ‘on’, current flows through capacitor 706 and capacitor 706 charges up to the voltage level at the emitter of the transistor 704.

When the voltage level on the reference signal R_{OUT}⁺ coupled to the base of transistor 704 decreases below the voltage level on the peak reference signal 516, transistor 704 turn ‘off’ and acts like an open circuit maintaining the peak reference signal 516 at the current peak reference voltage level. Transistor 704 is turned ‘on’ again when the voltage level on the converted reference signal increases above the current peak reference voltage on the peak reference signal 516. As the reference signal R_{OUT} is constantly unchanged, the capacitor 706 holds the voltage all the time.

Peak detector 500 includes transistors 708, 710, 712, 714 and capacitor 716. The emitters of each of the transistors 708, 710, 712, 714 are coupled together and to capacitor 716. While any one of transistors 708, 710, 712, 714 is ‘on’, capacitor 716 charges to the voltage level at the emitter of the respective transistor 708, 710, 712, 714.

Thus, a differential voltage on the 1ˆ 2+Qˆ 2 signal or on the I signal greater than the current peak voltage level on the signal peak signal 514 turns the respective transistor 708, 710, 712, 714 ‘on’ to charge up capacitor 716 to the peak signal voltage. Therefore, the voltage on the peak signal 516 is the peak signal voltage detected on either the Iˆ 2+Iˆ Q signal or the I signal. Before the I signal is recovered, the Iˆ 2+Qˆ 2 differential signal 708, 710 generates the peak signal voltage 514 to provide an estimated value for the AGC gain. As discussed in conjunction with FIG. 6A, there is a non-linear relationship between the amplitude of the Iˆ 2+Iˆ 2 signal and the I signal. After the I signal is recovered, the amplitude of the Iˆ 2+Qˆ 2 signal decreases much faster than the amplitude of the I signal. Thus, after the I signal is recovered, the I signal generates the peak signal voltage 514 to fine tune and maintain the AGC gain.

Before the I signal and Q signal are recovered, a differential voltage on the (1ˆ 2+Qˆ 2)⁺_{OUT} signal greater than the peak signal voltage 514 results in an emitter current in transistor 708. The amount of the emitter current is dependent on the voltage at the base of transistor 708. Capacitor 716 charges while there is an emitter current. Similarly, a negative differential voltage on the (Iˆ 2+Qˆ 2)⁻_{OUT} signal greater than the peak signal voltage 514 results in an emitter current in transistor 710. Capacitor 716 charges dependent on the emitter current. While the transistor is ‘off’ the base-emitter junction is reversed biased to maintain the detected peak voltage.

After the I signal is recovered, the peak signal voltage 514 is controlled by the I signal as the amplitude of the Iˆ 2+Qˆ 2 signal decreases below the amplitude of the I signal. Transistor 712 is turned ‘on’ by a positive differential voltage I⁺_{OUT} greater than the peak signal voltage 514 and transistor 714 turned ‘on’ by a negative differential voltage I_{OUT} greater than the peak signal voltage 514.

In the embodiment shown, the peak signal voltage 514 is the peak voltage detected on either the Iˆ 2+Qˆ 2 signal or the I signal. In an alternative embodiment, the I signal can be replaced by the Q signal or another pair of transistors can be added to the peak detector 500 to also detect the peak voltage on the Q signal. The addition of the transistors to the peak detector 500 to also detect the peak voltage on the Q signal increases the accuracy of the AGC gain.

Transistor 718 in peak detector 502 provides a bias current to maintain the reference peak voltage 516. The bias current is small when the peak detection transistors are ‘off’, typically on the order of 1 nano Amp (nA) to limit the leakage current. Similarly, transistors 720, 722, 724, 726 in peak detector 500 provide a bias current for the signal peak voltage 514.

The voltage levels on the peak signal voltage 514 and the peak reference signal 516 are dependent on the current supplied to the capacitors 706, 716, the capacitance of the capacitors 706, 716 and the charging time. For example, if a current I (t) is applied at time t=0, then the voltage at time t can be computed using the following equation:

$$V ( t ) = {V}_{0} + {\int }_{o}^{t} \frac{I}{C} I ( t ) ⅆ t t \geq 0$$

where V₀ is the initial voltage at t=0; and

C is the capacitance of the capacitor.

Thus, the respective bias current through the respective capacitor 706, 716 maintains the respective peak voltage 514, 516. Using the estimated amplitude signal to estimate the AGC gain before the I signal and Q signal are recovered allows recovery of the I signal and Q signal. Thus, the AGC gain is estimated in order to recover the carriers, and after the carriers are recovered, the AGC gain is accurately set by one or more of the recovered carriers.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for setting a gain in an automatic gain controller of a receiver comprising:
detecting a peak signal voltage from an estimated amplitude signal or a recovered carrier signal from a received signal; and
setting the gain dependent on a difference between the detected peak signal voltage and a peak reference voltage.

2. The method as claimed in claim 1 further comprising:
converting the estimated amplitude signal, the recovered carrier signal and a reference signal to a same common mode, the peak signal voltage being detected from the converted estimated amplitude signal and the converted recovered carrier signal.

3. The method as claimed in claim 2 further comprising:
detecting the peak reference voltage from the converted reference signal.

4. The method as claimed in claim 1 wherein the peak signal is detected from the estimated amplitude signal until the amplitude of the carrier signal decreases below the amplitude of the estimated amplitude signal.

5. The method as claimed in claim 4 wherein the peak signal is detected from the carrier signal after the carrier is recovered.

6. The method as claimed in claim 1 wherein the carrier signal is an I signal.

7. The method as claimed in claim 1 wherein the carrier signal is a Q signal.

8. The method as claimed in claim 1 wherein the carrier signal is an I signal and a Q signal.

9. An apparatus for setting gain in an automatic gain controller of a receiver comprising:
a first peak detector for detecting a signal peak voltage from an estimated amplitude signal or from a carrier signal recovered from a received signal; and
an integrator which sets the gain dependent on a difference between the peak signal voltage and a peak reference voltage.

10. The apparatus as claimed in claim 9 further comprising:
a converter for converting the estimated amplitude signal, the recovered carrier signal and a reference signal to a same common mode, the first peak detector detecting the signal peak voltage from the converted estimated amplitude signal and the converted recovered carrier signal.

11. The apparatus as claimed in claim 9 further comprising:
a second peak detector for detecting a peak reference voltage from the converted reference signal.

12. The apparatus as claimed in claim 9 wherein the peak signal voltage is detected from the estimated amplitude signal until the amplitude of the carrier signal decreases below the amplitude of the estimated amplitude signal.

13. The apparatus as claimed in claim 12 wherein the peak signal is detected from the I signal after the carrier is recovered.

14. The apparatus as claimed in claim 9 wherein the carrier signal is a I signal.

15. The apparatus as claimed in claim 9 wherein the carrier signal is a Q signal.

16. The apparatus as claimed in claim 9 wherein the carrier signal is an I signal and a Q signal.

17. The apparatus as claimed in claim 9 wherein the differential comparator includes a plurality of matched differential amplifiers.

18. The apparatus as claimed in claim 9 wherein the differential amplifiers have the same common mode rejection ratio.

19. An apparatus for setting a gain in an automatic gain controller of a receiver comprising:
means for detecting a peak signal voltage from an estimated amplitude signal or a recovered carrier from a received signal; and
means for setting the gain dependent on a difference between the detected peak signal voltage and a peak reference voltage.

20. The apparatus as claimed in claim 19 further comprising:
means for converting the estimated amplitude signal, the recovered carrier signal and a reference signal to a same common mode; and
means for detecting the peak signal voltage from the converted estimated amplitude signal and the converted carrier signal.

21. The apparatus as claimed in claim 20 further comprising:
means for detecting a peak reference voltage from the converted reference signal.

22. The apparatus as claimed in claim 19 wherein the peak signal is detected from the estimated amplitude signal until the amplitude of the carrier signal decreases below the amplitude of the estimated amplitude signal.

23. The apparatus as claimed in claim 22 wherein the peak signal is detected from the carrier signal after the carrier is recovered.

24. The apparatus as claimed in claim 19 wherein the carrier signal is an I signal.

25. The apparatus as claimed in claim 19 wherein the carrier signal is a Q signal.

26. The apparatus as claimed in claim 19 wherein the carrier signal is an I signal and a Q signal.

27. A method for setting the gain of a receiver in an automatic gain controller in the receiver comprising:
detecting a peak signal voltage from an estimated amplitude signal or a recovered carrier signal from a received signal, the peak signal detected from the estimated amplitude signal until the amplitude of the carrier signal decreases below the amplitude of the estimated amplitude signal and the peak signal detected from the recovered carrier signal after the carrier is recovered; and
setting the gain dependent on a difference between the detected peak signal voltage and a peak reference voltage.

28. An apparatus for setting gain of a receiver in an automatic gain controller in the receiver comprising:
a first peak detector for detecting a signal peak voltage from an estimated amplitude signal or from a carrier signal recovered from a received signal, the peak signal detected from the estimated amplitude signal until the amplitude of the carrier signal decreases below the amplitude of the estimated amplitude signal and the peak signal detected from the recovered carrier signal after the carrier is recovered; and
an integrator which sets the gain dependent on a difference between the peak signal voltage and a peak reference voltage.
